(19) United States
(12) Patent Application Publication
(10) Pub. No.: US 2025/0029310 A1
(43) Pub. Date: Jan. 23, 2025

(54) SYSTEMS AND METHODS FOR ELECTROMAGNETIC IMAGING

(71) Applicant: ATI Technologies ULC, Markham (CA)

(72) Inventor: Liam John Coffey, Markham (CA)

(73) Assignee: ATI Technologies ULC, Markham (CA)

(21) Appl. No.: 18/354,462

(22) Filed: Jul. 18, 2023

(51) Int. Cl. G06T 15/00; G06T 1/20; G06T 7/00

(52) U.S. Cl. CPC G06T 15/00; G06T 1/20; G06T 7/0002; G06T 2207/20081

(57) ABSTRACT

A computer-implemented method for electromagnetic imaging can include capturing, by at least one processor, electromagnetic image data of a sample. The method can also include converting, by the at least one processor, the electromagnetic image data to a multi-layer rasterized image. The method can further include comparing, by the at least one processor, the multi-layer rasterized image to a design file. Various other methods, systems, and computer-readable media are also disclosed.

### BACKGROUND

A gradiometer measures the gradient (e.g., numerical rate of change) of a physical quantity, such as a magnetic field or gravity. Gradiometers configured to measure magnetic fields can be of various types (e.g., axial, biaxial, triaxial, or planar). Gradiometers configured to measure magnetic fields use magnetometers, which are devices that measure magnetic field or magnetic dipole moment. One type of magnetometer is a fluxgate magnetometer, which is typically configured as a toroidally wrapped ring. Fluxgate magnetometers can also be configured as a pair of linear elements having drive windings each wound in opposing directions. However, linear coil geometry fell out of favor (e.g., in the 1950s and 1960s) due to issues with signal blowout stemming from significantly greater sensitivity of linear coils compared to toroidal coils. The common use of toroidal geometry coils limits the resolution when imaging field geometries and sampling field density.

### BRIEF DESCRIPTION OF THE DRAWINGS

The accompanying drawings illustrate a number of example embodiments and

are a part of the specification. Together with the following description, these drawings demonstrate and explain various principles of the present disclosure.

FIG. 1 is a block diagram of an example system for electromagnetic imaging.

FIG. 2 is a block diagram of an additional example system for electromagnetic imaging.

FIG. 3 is a flow diagram of an example method for electromagnetic imaging.

FIG. 4 is a perspective view of an imaging device for electromagnetic imaging.

FIG. 5 is a block diagram of a system for electromagnetic imaging.

FIG. 6 is a block diagram of a system for electromagnetic imaging.

Throughout the drawings, identical reference characters and descriptions indicate similar, but not necessarily identical, elements. While the example implementations described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to systems and methods for electromagnetic imaging. For example, by capturing electromagnetic image data of a sample, converting the electromagnetic image data to a multi-layer rasterized image, and comparing the multi-layer rasterized image to a design file, the disclosed systems and methods are able to produce deep detail images rapidly enough to be cost effective and without destructive delayering of the sample. In some implementations, many linear coils can be used with tight target areas to create an imaging sensor. In some of these implementations, machine learning can be used to alter the drive signal based on previous line-scan and rescan routines in a low latency adaptive manner, thus overcoming limitations that previously have blocked usage of this type of imaging. By using signal processing techniques and a feedback loop, the operation of a linear coil can be rapidly changed as needed to avoid signal blowout while realizing the benefits of significantly greater linear coil sensitivity compared to that of a toroidal coil.

The disclosed systems and methods can be applied in various ways. For example, the disclosed systems and methods can be applied to inspection of in-line samples by electromagnetic imaging. In some implementations, a Linear Polyaxial Fluxgate Gradiometer (LPFG) at various physical scales (e.g., an array of magnetometers) can be used, in a machine learning driven test system, to produce high-resolution, all-layer vector images of in-line samples. Example samples can include fabricated monolithic chip, chiplet on wafer, loose cut, and/or on package products. The inspection can be performed at multiple stages of post-fabrication manufacturing without harm to the sample and, in many cases, with the sample being unpowered. Unlike previous techniques used to image silicon (e.g., conventional microscopy), the disclosed techniques can produce images of silicon at a scale as low as three nanometers in terms of package size, producing electromagnetic image detail at an angstrom and/or atomic level.

The disclosed systems and methods can realize numerous benefits, such as assuring design integrity of products in modern security scenarios. Additionally, investigation into competitors' silicon and/or vendors' silicon can be performed for detecting infringement of intellectual property rights in higher quantities and at lower cost than is currently achievable. Also, design investigation can detect defects earlier in a workflow and decrease defects on package, thus lowering the cost of silicon manufacturing. Further, issues like routine contamination issues, systematic defect occurrence, and device analysis for things like fuse errors can be caught earlier in batch sendoffs. With the disclosed techniques, one or more detection and/or validation processes that normally require many weeks (e.g., forty-two weeks) can be performed in amounts of time reduced by many orders of magnitude (e.g., eight seconds).

In one example, a computing device includes image capture circuitry configured to capture electromagnetic image data of a sample, vector processing circuitry configured to convert the electromagnetic image data to a multi-layer rasterized image, and application comparison circuitry configured to compare the multi-layer rasterized image to a design file.

Another example can be the previously described computing device, wherein the image capture circuitry is configured to capture the electromagnetic image data using an array of magnetometers.

Another example can be any of the previously described computing devices, wherein the array of magnetometers is configured as a linear polyaxial fluxgate gradiometer.

Another example can be any of the previously described computing devices, wherein the vector processing circuitry is configured to convert the electromagnetic image data to the multi-layer rasterized image using a vector processing engine that includes a machine learning model trained on the design file.

Another example can be any of the previously described computing devices, wherein the vector processing engine is configured to generate a filtered vector point list and the machine learning model is further trained on the filtered vector point list.

Another example can be any of the previously described computing devices, wherein the sample corresponds to at least one of a fabricated monolithic chip, a chiplet on wafer semiconductor device, a loose cut semiconductor device, or an on package semiconductor device.

Another example can be any of the previously described computing devices, further including result analysis circuitry configured to employ a result of the comparison to at least one of validate that no malicious circuitry has been injected in the sample, detect evidence of infringement, by the sample, of intellectual property, detect a defect in the sample, or perform silicon validation of the sample.

In one example, a system can include an electromagnetic imaging device, at least one physical processor coupled to the electromagnetic imaging device, and physical memory comprising computer-executable instructions that, when executed by the at least one physical processor, cause the at least one physical processor to capture electromagnetic image data of a sample by using the electromagnetic imagining device, convert the electromagnetic image data to a multi-layer rasterized image, and compare the multi-layer rasterized image to a design file.

Another example can be the previously described system, wherein the electromagnetic imaging device includes an array of magnetometers.

Another example can be any of the previously described example systems, wherein the array of magnetometers is configured as a linear polyaxial fluxgate gradiometer.

Another example can be any of the previously described example systems, wherein the computer-executable instructions cause the at least one physical processor to convert the electromagnetic image data to the multi-layer rasterized image using a vector processing engine that includes a machine learning model trained on the design file.

Another example can be any of the previously described example systems, wherein the computer-executable instructions cause the at least one physical processor to generate a filtered vector point list and the machine learning model is further trained on the filtered vector point list.

Another example can be any of the previously described example systems, wherein the sample corresponds to at least one of a fabricated monolithic chip, a chiplet on wafer semiconductor device, a loose cut semiconductor device, or an on package semiconductor device.

Another example can be any of the previously described example systems, wherein the computer-executable instructions further cause the at least one physical processor to employ a result of the comparison to at least one of validate that no malicious circuitry has been injected in the sample, detect evidence of infringement, by the sample, of intellectual property, detect a defect in the sample, or perform silicon validation of the sample.

In one example, a computer-implemented method can include capturing, by at least one processor, electromagnetic image data of a sample, converting, by the at least one processor, the electromagnetic image data to a multi-layer rasterized image, and comparing, by the at least one processor, the multi-layer rasterized image to a design file.

Another example can be the previously described example method, wherein the at least one processor is configured to capture the electromagnetic image data using an array of magnetometers configured as a linear polyaxial fluxgate gradiometer.

Another example can be any of the previously described example methods, wherein the at least one processor is configured to convert the electromagnetic image data to the multi-layer rasterized image using a vector processing engine that includes a machine learning model trained on the design file.

Another example can be any of the previously described example methods, wherein the vector processing engine is configured to generate a filtered vector point list and the machine learning model is further trained on the filtered vector point list.

Another example can be any of the previously described example methods, wherein the sample corresponds to at least one of a fabricated monolithic chip, a chiplet on wafer semiconductor device, a loose cut semiconductor device, or an on package semiconductor device.

Another example can be any of the previously described example methods, further comprising employing a result of the comparison to at least one of validate that no malicious circuitry has been injected in the sample, detect evidence of infringement, by the sample, of intellectual property, detect a defect in the sample, or perform silicon validation of the sample.

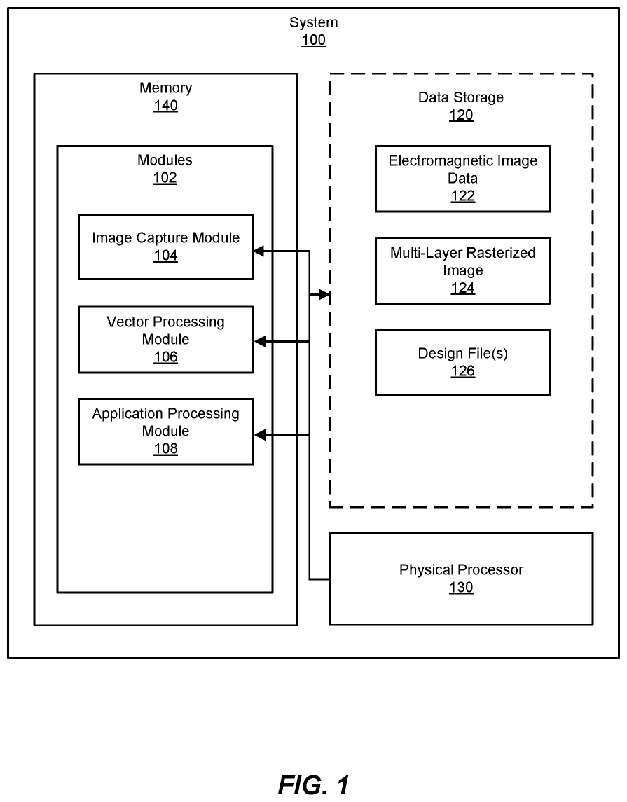

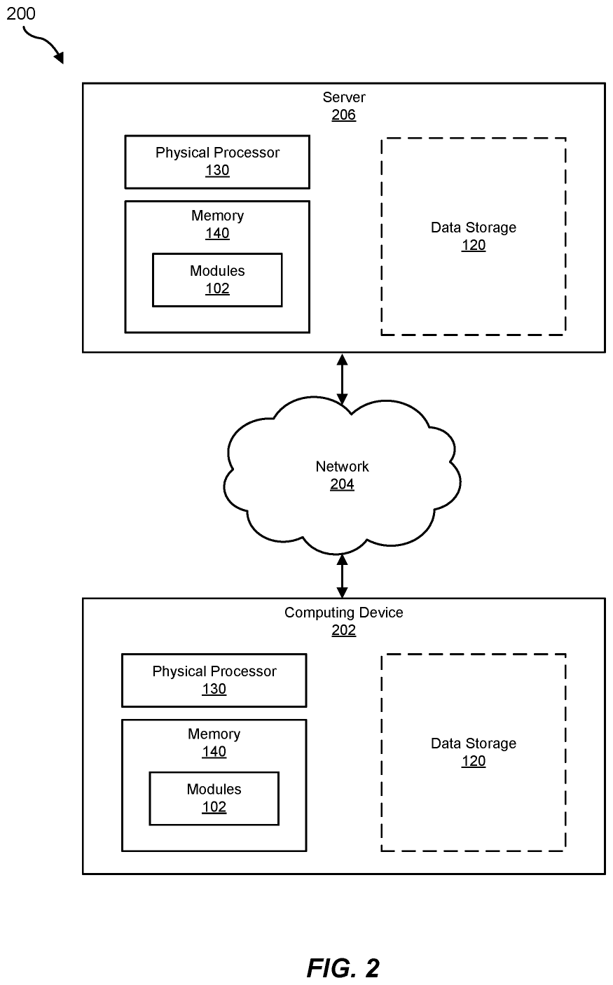

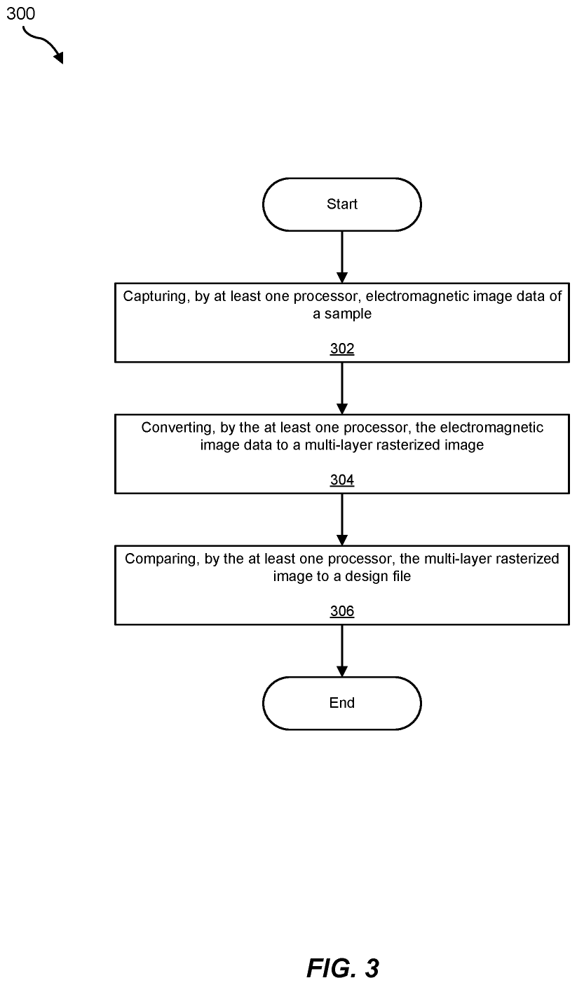

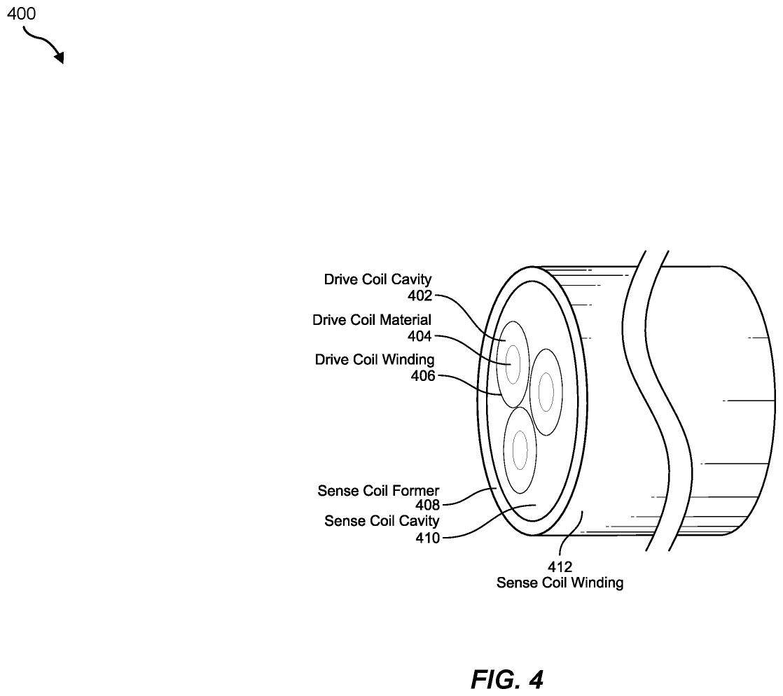

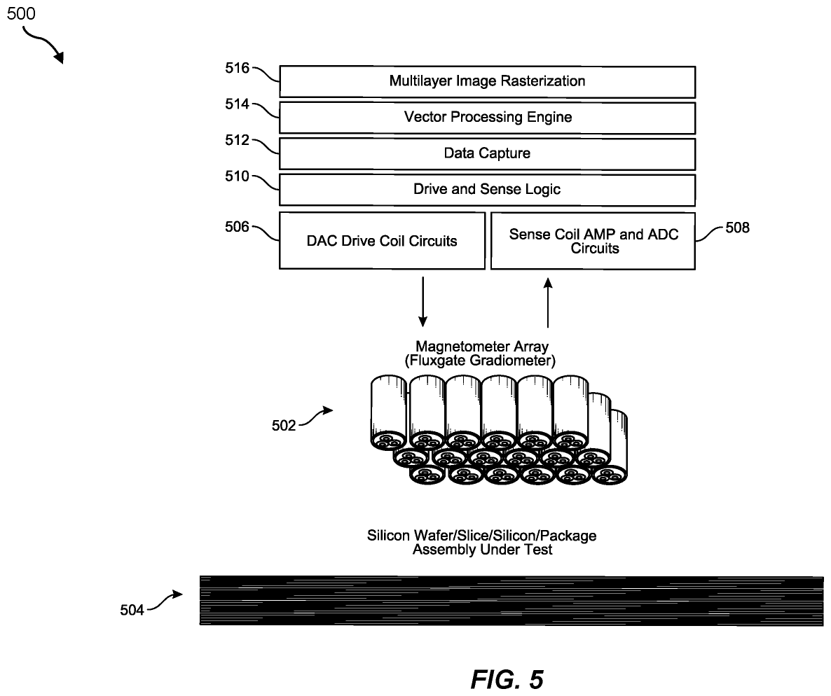

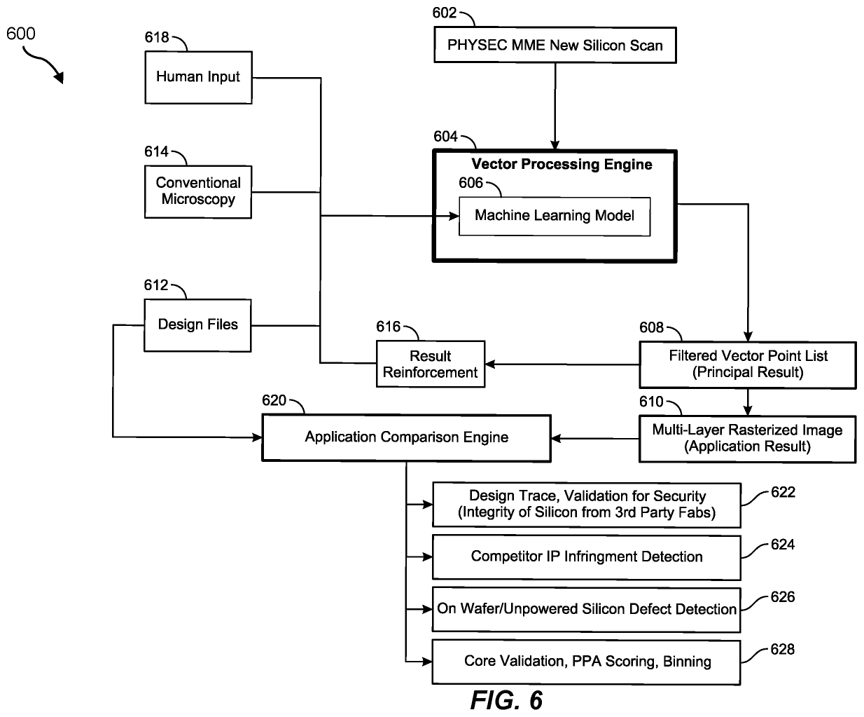

The following will provide, with reference to FIGS. 1 and 2, detailed descriptions of example systems for electromagnetic imaging. Detailed descriptions of corresponding computer-implemented methods will also be provided in connection with FIG. 3. In addition, detailed descriptions of example imaging devices for electromagnetic imaging will be provided in connection with FIG. 4. Also, detailed descriptions of example systems for electromagnetic imaging will be provided in connections with FIGS. 5 and 6.

FIG. 1 is a block diagram of an example system 100 for electromagnetic imaging. As illustrated in this figure, example system 100 can include one or more modules 102 for performing one or more tasks. As will be explained in greater detail below, modules 102 can include an image capture module 104, a vector processing module 106, and an application processing module 108. Although illustrated as separate elements, one or more of modules 102 in FIG. 1 can represent portions of a single module or application.

In certain implementations, one or more of modules 102 in FIG. 1 can represent one or more software applications or programs that, when executed by a computing device, can cause the computing device to perform one or more tasks. For example, and as will be described in greater detail below, one or more of modules 102 can represent modules stored and configured to run on one or more computing devices, such as the devices illustrated in FIG. 2 (e.g., computing device 202 and/or server 206). One or more of modules 102 in FIG. 1 can also represent all or portions of one or more special-purpose computers configured to perform one or more tasks.

As illustrated in FIG. 1, example system 100 can also include one or more memory devices, such as memory 140. Memory 140 generally represents any type or form of volatile or non-volatile storage device or medium capable of storing data and/or computer-readable instructions. In one example, memory 140 can store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 1, example system 100 can also include one or more physical processors, such as physical processor 130. Physical processor 130 generally represents any type or form of hardware-implemented processing unit capable of interpreting and/or executing computer-readable instructions. In one example, physical processor 130 can access and/or modify one or more of modules 102 stored in memory 140. Additionally or alternatively, physical processor 130 can execute one or more of modules 102 to facilitate electromagnetic imaging. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

The term “modules,” as used herein, can generally refer to one or more functional components of a computing device. For example, and without limitation, a module or modules can correspond to hardware, software, or combinations thereof. In turn, hardware can correspond to analog circuitry, digital circuitry, communication media, or combinations thereof. In some implementations, the modules can be implemented as microcode (e.g., a collection of instructions running on a micro-processor, digital and/or analog circuitry, etc.) and/or one or more firmware in a graphics processing unit. For example, a module can correspond to a GPU, a trusted micro-processor of a GPU, and/or a portion thereof (e.g., circuitry (e.g., one or more device features sets and/or firmware) of a trusted micro-processor).

As illustrated in FIG. 1, example system 100 can also include one or more instances of stored data, such as data storage 120. Data storage 120 generally represents any type or form of stored data, however stored (e.g., signal line transmissions, bit registers, flip flops, software in rewritable memory, configurable hardware states, combinations thereof, etc.). Examples of data storage 120 include, without limitation, electromagnetic image data 122, multi-layer rasterized image 124, and design files 126.

Example system 100 in FIG. 1 can be implemented in a variety of ways. For example, all or a portion of example system 100 can represent portions of example system 200 in FIG. 2. As shown in FIG. 2, system 200 can include a computing device 202 in communication with a server 206 via a network 204. In one example, all or a portion of the functionality of modules 102 can be performed by computing device 202, server 206, and/or any other suitable computing system. As will be described in greater detail below, one or more of modules 102 from FIG. 1 can, when executed by at least one processor of computing device 202 and/or server 206, enable computing device 202 and/or server 206 to perform electromagnetic imaging.

Computing device 202 generally represents any type or form of computing device capable of reading computer-executable instructions. For example, computing device 202 can include a processing unit of an in-line sample inspection workstation. Example processing units can include one or more central processing unit (CPUs), arithmetic and logic units (ALUs), graphics processing units (GPUs), accelerator processing units (ACUs), deep learning processors, physical processing units (PPUs), field programmable gate arrays (FPGAs), synergistic processing units (SPUs), synergistic processing elements (SPEs), microprocessors, or combinations thereof. Additional examples of computing device 202 include, without limitation, platforms such as laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device. Alternatively or additionally, computing device 202 can correspond to a device operating within such a platform.

Server 206 generally represents any type or form of computing device that is capable of reading computer-executable instructions. For example, server 206 can include a processing unit in communication with one or more in-line sample inspection workstations. Example processing units can include one or more central processing unit (CPUs), arithmetic and logic units (ALUs), graphics processing units (GPUs), accelerator processing units (ACUs), deep learning processors, physical processing units (PPUs), field programmable gate arrays (FPGAs), synergistic processing units (SPUs), synergistic processing elements (SPEs), microprocessors, or combinations thereof. Additional examples of server 206 include, without limitation, storage servers, database servers, application servers, and/or web servers configured to run certain software applications and/or provide various storage, database, and/or web services. Although illustrated as a single entity in FIG. 2, server 206 can include and/or represent a plurality of servers that work and/or operate in conjunction with one another.

Network 204 generally represents any medium or architecture capable of facilitating communication or data transfer. In one example, network 204 can facilitate communication between computing device 202 and server 206. In this example, network 204 can facilitate communication or data transfer using wireless and/or wired connections. Examples of network 204 include, without limitation, a Peripheral Component Interconnect express (PICe) bus, a Nonvolatile memory express (Nvme) bus, a Local Area Network (LAN), a Personal Area Network (PAN), Power Line Communications (PLC), portions of one or more of the same, variations or combinations of one or more of the same, or any other suitable network that enables the computing device 202 to perform data communication with other components on the platform of server 206. In other examples, network 204 can be an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to system 100 in FIG. 1 and/or system 200 in FIG. 2. Conversely, all of the components and devices illustrated in FIGS. 1 and 2 need not be present to practice the implementations described and/or illustrated herein. The devices and subsystems referenced above can also be interconnected in different ways from that shown in FIG. 2. Systems 100 and 200 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

FIG. 3 is a flow diagram of an example computer-implemented method 300 for electromagnetic imaging. The steps shown in FIG. 3 can be performed by any suitable computer-executable code and/or computing system, including system 100 in FIG. 1, system 200 in FIG. 2, and/or variations or combinations of one or more of the same. In one example, each of the steps shown in FIG. 3 can represent an algorithm whose structure includes and/or is represented by multiple sub-steps, examples of which will be provided in greater detail below.

The term “computer-implemented method,” as used herein, can generally refer to a method performed by hardware or a combination of hardware and software. For example, hardware can correspond to analog circuitry, digital circuitry, communication media, or combinations thereof. In some implementations, hardware can correspond to digital and/or analog circuitry arranged to carry out one or more portions of the computer-implemented method. In some implementations, hardware can correspond to physical processor 130 of FIG. 1. Additionally, software can correspond to software applications or programs that, when executed by the hardware, can cause the hardware to perform one or more tasks that carry out one or more portions of the computer-implemented method. In some implementations, software can correspond to one or more of modules 102 stored in memory 140 of FIG. 1.

As illustrated in FIG. 3, at step 302 one or more of the systems described herein can capture electromagnetic image data. For example, image capture module 104 can, as part of computing device 202 in FIG. 2, capture electromagnetic image data of a sample.

The term “electromagnetic image data,” as used herein, can generally refer to data representing an image of an object produced by the use of electromagnetic fields (e.g., from static to microwave and higher frequencies). For example, and without limitation, electromagnetic image data can represent gamma ray, infrared, and/or X-ray images. In this context, the term “capture,” as used herein, can generally refer to using a process similar to magnetic resonance imaging (MRI), computed tomography (CT), and/or positron emission topography (PET) to generate the electromagnetic image data.

The term “sample,” as used herein, can generally refer to a scanned object containing dielectric material. For example, and without limitation, a sample can correspond to a silicon wafer and/or package, such as a fabricated monolithic chip, a chiplet on wafer semiconductor device, a loose cut semiconductor device, and/or an on package semiconductor device. Additionally or alternatively, the systems and methods disclosed herein can be scaled up to image larger samples containing dielectric materials (e.g., vehicle frames).

The systems described herein can perform step 302 in a variety of ways. In one example, image capture module 104 can, as part of computing device 202 in FIG. 2, capture the electromagnetic image data using an array of magnetometers configured as a linear polyaxial fluxgate gradiometer. In some implementations, image capture module 104 can, as part of computing device 202 in FIG. 2, capture electromagnetic image data of a sample that corresponds to a fabricated monolithic chip, a chiplet on wafer semiconductor device, a loose cut semiconductor device, or an on package semiconductor device.

At step 304 one or more of the systems described herein can convert electromagnetic image data. For example, vector processing module 106 can, as part of computing device 202 in FIG. 2, convert the electromagnetic image data to a multi-layer rasterized image.

The term “vector processing,” as used herein, can generally refer to a type of processing (e.g., processor) that performs arithmetic operations on a large array of integers or floating-point numbers. For example, and without limitation, vector processing can operate on all the elements of the array in parallel, with each pass being independent of the other. Vector processing can avoid the overhead of a loop control mechanism that occurs in general-purpose computers.

The term “rasterized image,” as used herein, can generally refer to an image that is produced when scanning or photographing an object. For example, and without limitation, rasterized images can be compiled using pixels, or tiny dots, containing unique color and tonal information that come together to create the image. Since rasterized images are pixel based, they can be resolution dependent. Generally speaking, vector graphics can be digital art that is rendered by a computer using a mathematical formula, whereas raster images are made up of tiny pixels, making them resolution dependent and best used for creating photos. Thus, the “rasterized” images can be produced by converting vector graphics (e.g., provided as a filtered vector point list) to pixels. In this context, the term “multi-layer” can generally refer to multiple arrays of pixels, each representing an imaging plane (e.g., as similarly results from magnetic resonance imaging (MRI)).

The systems described herein can perform step 304 in a variety of ways. In one example, vector processing module 106 can, as part of computing device 202 in FIG. 2, convert the electromagnetic image data to the multi-layer rasterized image using a vector processing engine that includes a machine learning model trained on a design file. In some of these implementations, the vector processing engine can be configured to generate a filtered vector point list and the machine learning model can be further trained on the filtered vector point list.

At step 306 one or more of the systems described herein can compare the multi-layer rasterized image. For example, application processing module 108 can, as part of computing device 202 in FIG. 2, compare the multi-layer rasterized image to a design file.

The systems described herein can perform step 304 in a variety of ways. In one example, application processing module 108 can, as part of computing device 202 in FIG. 2, compare the multi-layer rasterized image to a design file on which the machine learning model employed in step 304 is trained. In various implementations, a result of the comparison can be employed to at least one of validate that no malicious circuitry has been injected in the sample, detect evidence of infringement, by the sample, of intellectual property, detect a defect in the sample, or perform silicon validation of the sample. In some of these implementations, application processing module 108 can, as part of computing device 202 in FIG. 2, automatically perform any or all of these validations and/or detections. In some of these implementations, application processing module 108 can, as part of computing device 202 in FIG. 2, generate an output, such as an alert or an alarm, and/or start, stop, or continue a process based on the result of the comparison and or results of the automated validations and/or detections. Alternatively or additionally, application processing module 108 can, as part of computing device 202 in FIG. 2, output the result of the comparison (e.g., with or without the multi-layer rasterized image and/or design file) for offline analysis by an expert.

Steps 302-306 can be implemented in various ways for various types of applications. For example, in an application that validates that no malicious circuitry has been injected in a sample, the sample imaged in step 302 can correspond to one or more products or product components (e.g., powered and/or unpowered) provided by a vendor and the design files employed in steps 304 and 306 can include design files for one or more products or product components and/or design files for one or more malicious circuits that could be injected into the sample. Additionally, in an application that detects evidence of infringement, the sample imaged in step 302 can correspond to one or more competitor's products (e.g., powered and/or unpowered) and the design files employed in steps 304 and 306 can include design files for one or more circuits of the sample and/or design files for one or more circuits that are protected as intellectual property. Also, in an application that detects a defect in a sample, the sample imaged in step 302 can correspond to one or more unpowered products that are in the process of being manufactured and the design files employed in steps 304 and 306 can include design files for one or more circuits and/or circuit elements of the one or more unpowered products that are in the process of being manufactured. In such applications, steps 302-306 can be repeated at various stages of product manufacture using design files that can be tailored to a state of the product to be expected at a particular stage of manufacture. Further, in an application that performs silicon validation of a sample, the sample imaged in step 302 can correspond to one or more products that have been manufactured and the design files employed in steps 304 and 306 can include design files for one or more circuits and/or circuit elements of the product that has been manufactured. In such applications, steps 302-306 can be performed while operating the product in one or more application environments to validate correct behaviors over specified operating conditions.

As shown in FIG. 4, an imaging device 400 for electromagnetic imaging can include one or more linear coil elements of a polyaxial fluxgate magnetometer. For example, the linear coil element can include linear drive coil elements and linear sense coil elements arranged as shown. Example linear drive coil elements can include a drive coil cavity 402, drive coil material 404 surrounded by the drive coil cavity 402, and a drive coil winding 406 about the drive coil cavity 402. Three or more sets of these linear drive coil elements can be included in the linear coil element and be collectively surrounded by the linear sense coil elements. Example linear sense coil elements can include a sense coil former 408 surrounding the three or more sets of linear drive coil elements, a sense coil cavity 410 between the sense coil former 408 and the three or more sets of drive coil elements, and a sense coil winding 412 about the sense coil former 408.

A typical fluxgate magnetometer can have a coil surrounding an inner drive coil that is wound around permeable core material. Each sensor can have magnetic core elements that can be viewed as two carefully matched halves. An alternating current can be applied to the drive winding, which drives the core into plus and minus saturation. The instantaneous drive current in each core half can be driven in opposite polarity with respect to any external magnetic field. In the absence of any external magnetic field, the flux in one core half cancels that in the other and the total flux seen by the sense coil is zero. When an external magnetic field is applied, it can, at a given instance in time, aid the flux in one core half and oppose flux in the other. This causes a net flux imbalance between the halves, so that they no longer cancel one another. Current pulses can be induced in the sense winding on every drive current phase reversal (or at the 2nd, and all even harmonics). This inducement can result in a signal that is dependent on both the external field magnitude and polarity.

Adding a third set of linear drive coil elements to a linear coil element of a polyaxial fluxgate magnetometer, as shown in FIG. 4, provides various enhanced capabilities and options. For example, a third drive core can be driven in sympathy or antipathy with another drive core to adjust sensitivity of the linear electromagnetic imaging sensor element. Additionally, the third drive core can be driven individually and as needed to reduce sensitivity of the linear electromagnetic imaging sensor element, thus avoiding (e.g., reducing or eliminating) signal blowout. A feedback loop can be employed to control (e.g., switch, drive, etc.) the third drive core based, for example, on signal strength of sensory input from the other two coils, thus avoiding signal blowout while preserving the ability of the linear coil elements to image at levels of detail orders of magnitude greater than can be achieved with a toroidal coil. Configuring imaging device 400 with many such linear coil elements with very tight target areas can result in an electromagnetic imaging sensor. Numerous imaging devices 400 of varying sizes (e.g., circumferences, numbers of windings, and/or lengths) and angles (e.g., polyaxial) can be implemented as an array of magnetometers that provides numerous sensory inputs for target areas at various sensitivities. Machine learning can be employed to individually control each imaging device 400 of this linear polyaxial fluxgate magnetometer to generate numerous such sensory inputs and apply them to generate a rasterized image while avoiding signal blowout.

As shown in FIG. 5, a system 500 for electromagnetic imaging can control the magnetometer array 502 (e.g., linear fluxgate magnetometer array) in imaging a sample 504 (e.g., silicon wafer, slice, silicon, package, etc.) under test. For example, the magnetometer array 502 and sample 504 can remain stationary while an electromagnetic source positioned on a side of sample 504 opposite array 502 is varied (e.g., in one, two, or three dimensions (e.g., x, y, and/or z directions)) to scan sample 504 in the imaging process. During this process, sample 504 can be powered and/or unpowered.

System 500 can include digital to analog conversion (DAC) drive coil circuits 506 and sense coil amplification (AMP) and analog to digital conversion (ADC) circuits 508. DAC drive coil circuits 506 and AMP/ADC circuits 508 can couple magnetometer array 502 to at least one processor, such as physical processor 130 of FIGS. 1 and 2, containing drive and sense coil logic 510. Drive and sense logic 510 can use the DAC drive coil circuits 506 to drive the drive coils of magnetometer array 502 and use the AMP/ADC circuits 508 to receive sensory signals from sense coils of magnetometer array 502 and convert them to electromagnetic image data. Data capture engine 512 can operate (e.g., trigger and/or control) drive and sense logic 510 and receive the electromagnetic image data. Vector processing engine 514 can process this electromagnetic image data (e.g., with machine learning) to perform a multi-layer image rasterization 516.

As shown in FIG. 6, a system 600 for electromagnetic imaging can process scanning results obtained by system 500. For example, a physical security (PHYSEC) magnetic-mechano-electric (MME) new silicon scan 602 can provide electromagnetic imaging data to vector processing engine 604 in any manner described herein. Vector processing engine 604 can employ a machine learning model 606 to generate a filtered vector point list 608 as a principal result, which can be used as result reinforcement 616 for machine learning model 606 and also can be converted to a multi-layered rasterized image 610 as an application result. Machine learning model 606 can employ a trained electromagnetic image quality model to improve operation of vector processing engine 604 to reduce or avoid (e.g., reduce or eliminate) signal blowout in the vector point list 608 and multi-layered rasterized image 610. In some examples, machine learning model 606 can be a probabilistic model subjectively trained on design files 612, conventional microscopy 614, result reinforcement 616, and user input 618 (e.g., end user decisions). User input can indicate applicable types of design files 612, quality of electromagnetic imaging results (e.g., filtered vector point list 608) achieved using design files 612, sample types, target areas of samples, etc. In some of these examples, a set of training data can be prepared by labeling electromagnetic imaging results according to various criteria, such as applicable types of design files 612. The electromagnetic imaging results can also be analyzed and labeled by various parameters, such as drive coil and sense coil control parameters utilized in scan 602. End users can rate the quality of the electromagnetic imaging results and indicate one or more locations in frame where they perceive the quality to be good or bad. Results of this process can be used for network training to produce a trained probabilistic model that can assess applicable design files 612, control parameters for imaging target areas of a sample in scan 602, etc. Thus, machine learning model 606 can be generated (e.g., per rasterized image, per rasterized image layer, and/or portion thereof (e.g., target area of a sample)). Alternatively or additionally, machine learning model 606 can be developed using self-guided network training based on inputs that include electromagnetic imaging results reinforcement 616, design files 612, and/or conventional microscopy 614.

Application comparison engine 620 can match design files 612 with one or more multi-layered rasterized image 610 using, for example, one or more image recognition techniques. By generating comparison results, application comparison engine 620 can generate various types of outputs that can be used in various ways. For example, application comparison engine 620 can use a result of the comparison to perform design trace validation 622 of vendor silicon integrity for security by validating that no malicious circuitry has been injected in a sample. Additionally or alternatively, application comparison engine 620 can use a result of the comparison to perform competitor intellectual property infringement detection 624 by comparing multi-layered rasterized image 610 to design files relating to intellectual property. This process can, for example, compare imaging results for scans of vendor silicon to design files for intellectual property of competitors, thus aiding in avoiding infringement of competitor intellectual property. Alternatively or additionally, this process can compare imaging results of competitor silicon to design files for intellectual property of a user (e.g., user's employer), thus detecting infringement of the intellectual property. Additionally or alternatively, application comparison engine 620 can use a result of the comparison to perform defect detection 626 of on wafer, unpowered silicon at one or more stages of manufacture of the silicon. Additionally or alternatively, application comparison engine 620 can use a result of the comparison to perform core validation 628 of powered silicon, with power, performance, and area (PPA) scoring and binning that can provide a behavioral analysis of the circuit.

In some of these implementations, application comparison engine 620 can automatically perform any or all of the validations 622 and 628 and/or detections 624 and 626. In some of these implementations, application comparison engine 620 can generate an output, such as an alert or an alarm, and/or start, stop, or continue a process based on the result of the comparison and or results of the automated validations 622 and 628 and/or detections 624 and 626. Alternatively or additionally, application comparison engine 620 can output the result of the comparison (e.g., with or without the multi-layer rasterized image 610 and/or design file 612) for offline analysis by an expert. Such an expert can then analyze the comparison results and provide user input 618 (labels, weights, promotions, demotions, etc. of points of filtered vector points list 608) used as result reinforcement 616 to train machine learning model 606.

System 600 can be implemented in various ways for various types of applications. For example, in an application that validates that no malicious circuitry has been injected in a sample imaged in scan 602, the sample can correspond to one or more products or product components (e.g., powered and/or unpowered) provided by a vendor and the design files 612 can include design files for one or more products or product components and/or design files for one or more malicious circuits that could be injected into the sample. Additionally, in an application that detects evidence of infringement, the sample imaged in scan 602 can correspond to one or more competitor's products (e.g., powered and/or unpowered) and the design files 612 can include design files for one or more circuits of the sample and/or design files for one or more circuits that are protected as intellectual property. Also, in an application that detects a defect in a sample, the sample imaged in scan 602 can correspond to one or more unpowered products that are in the process of being manufactured and the design files 612 can include design files for one or more circuits and/or circuit elements of the one or more unpowered products that are in the process of being manufactured. In such applications, system 600 can be employed at various stages of product manufacture using design files 612 that can be tailored to a state of the product to be expected at a particular stage of manufacture. Further, in an application that performs silicon validation of a sample, the sample imaged in scan 602 can correspond to one or more products that have been manufactured and the design files 612 can include design files for one or more circuits and/or circuit elements of the product that has been manufactured. In such applications, system 600 can be employed while operating the product in one or more application environments to validate correct behaviors over specified operating conditions.

As set forth above, the disclosed systems and methods for electromagnetic imaging can capture electromagnetic image data of a sample, convert the electromagnetic image data to a multi-layer rasterized image, and compare the multi-layer rasterized image to a design file. By doing so, the disclosed systems and methods can produce deep detail images rapidly enough to be cost effective and without destructive delayering of the sample. In some implementations, many linear coils can be used with tight target areas to create an imaging sensor. In some of these implementations, machine learning can be used to alter the drive signal based on previous line-scan and rescan routines in a low latency adaptive manner, thus overcoming limitations that previously have blocked usage of this type of imaging. By using signal processing techniques and a feedback loop, the operation of a linear coil can be rapidly changed as needed to avoid signal blowout while realizing the benefits of significantly greater linear coil sensitivity compared to that of a toroidal coil.

As also set forth above, the disclosed systems and methods can be applied in various ways. For example, the disclosed systems and methods can be applied to inspection of in-line samples by electromagnetic imaging. In some implementations, a Linear Polyaxial Fluxgate Gradiometer (LPFG) at various physical scales (e.g., an array of magnetometers) can be used, in a machine learning driven test system, to produce high-resolution, all-layer vector images of in-line samples. Example samples can include fabricated monolithic chip, chiplet on wafer, loose cut, and/or on package products. The inspection can be performed at multiple stages of post-fabrication manufacturing without harm to the sample and, in many cases, with the sample being unpowered. Unlike previous techniques used to image silicon (e.g., conventional microscopy), the disclosed techniques can produce images of silicon at a scale as low as three nanometers in terms of package size, producing electromagnetic image detail at an angstrom and/or atomic level.

The disclosed systems and methods can realize numerous benefits, such as assuring design integrity of products in modern security scenarios. Additionally, investigation into competitors' silicon and/or vendors' silicon can be performed for detecting infringement of intellectual property rights in higher quantities and at lower cost than is currently achievable. Also, design investigation can detect defects earlier in a workflow and decrease defects on package, thus lowering the cost of silicon manufacturing. Further, issues like routine contamination issues, systematic defect occurrence, and device analysis for things like fuse errors can be caught earlier in batch sendoffs. With the disclosed techniques, processes that normally require many weeks (e.g., forty-two weeks) can be performed in amounts of time reduced by many orders of magnitude (e.g., eight seconds).

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 100 in FIG. 1 can be implemented within a virtual environment. For example, the modules and/or data described herein can reside and/or execute within a virtual machine. As used herein, the term “virtual machine” generally refers to any operating system environment that is abstracted from computing hardware by a virtual machine manager (e.g., a hypervisor).

In some examples, all or a portion of example system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computing device, comprising:
image capture circuitry configured to capture electromagnetic image data of a sample;
vector processing circuitry configured to convert the electromagnetic image data to a multi-layer rasterized image; and
application comparison circuitry configured to compare the multi-layer rasterized image to a design file.

2. The computing device of claim 1, wherein the image capture circuitry is configured to capture the electromagnetic image data using an array of magnetometers.

3. The computing device of claim 2, wherein the array of magnetometers is configured as a linear polyaxial fluxgate gradiometer.

4. The computing device of claim 1, wherein the vector processing circuitry is configured to convert the electromagnetic image data to the multi-layer rasterized image using a vector processing engine that includes a machine learning model trained on the design file.

5. The computing device of claim 4, wherein the vector processing engine is configured to generate a filtered vector point list and the machine learning model is further trained on the filtered vector point list.

6. The computing device of claim 1, wherein the sample corresponds to at least one of:
a fabricated monolithic chip;
a chiplet on wafer semiconductor device;
a loose cut semiconductor device; or
an on package semiconductor device.

7. The computing device of claim 1, further comprising:
result analysis circuitry configured to employ a result of the comparison to at least one of:
validate that no malicious circuitry has been injected in the sample;
detect evidence of infringement, by the sample, of intellectual property;
detect a defect in the sample; or
perform silicon validation of the sample.

8. A system comprising:
an electromagnetic imaging device;
at least one physical processor coupled to the electromagnetic imaging device; and
physical memory comprising computer-executable instructions that, when executed by the at least one physical processor, cause the at least one physical processor to:
capture electromagnetic image data of a sample by using the electromagnetic imaging device;
convert the electromagnetic image data to a multi-layer rasterized image; and
compare the multi-layer rasterized image to a design file.

9. The system of claim 8, wherein the electromagnetic imaging device includes an array of magnetometers.

10. The system of claim 9, wherein the array of magnetometers is configured as a linear polyaxial fluxgate gradiometer.

11. The system of claim 8, wherein the computer-executable instructions cause the at least one physical processor to convert the electromagnetic image data to the multi-layer rasterized image using a vector processing engine that includes a machine learning model trained on the design file.

12. The system of claim 11, wherein the computer-executable instructions cause the at least one physical processor to generate a filtered vector point list and the machine learning model is further trained on the filtered vector point list.

13. The system of claim 8, wherein the sample corresponds to at least one of:
a fabricated monolithic chip;
a chiplet on wafer semiconductor device;
a loose cut semiconductor device; or
an on package semiconductor device.

14. The system of claim 8, wherein the computer-executable instructions further cause the at least one physical processor to:
employ a result of the comparison to at least one of:
validate that no malicious circuitry has been injected in the sample;
detect evidence of infringement, by the sample, of intellectual property;
detect a defect in the sample; or
perform silicon validation of the sample.

15. A computer-implemented method comprising:
capturing, by at least one processor, electromagnetic image data of a sample;
converting, by the at least one processor, the electromagnetic image data to a multi-layer rasterized image; and
comparing, by the at least one processor, the multi-layer rasterized image to a design file.

16. The computer-implemented method of claim 15, wherein the at least one processor is configured to capture the electromagnetic image data using an array of magnetometers configured as a linear polyaxial fluxgate gradiometer.

17. The computer-implemented method of claim 15, wherein the at least one processor is configured to convert the electromagnetic image data to the multi-layer rasterized image using a vector processing engine that includes a machine learning model trained on the design file.

18. The computer-implemented method of claim 17, wherein the vector processing engine is configured to generate a filtered vector point list and the machine learning model is further trained on the filtered vector point list.

19. The computer-implemented method of claim 15, wherein the sample corresponds to at least one of:
a fabricated monolithic chip;
a chiplet on wafer semiconductor device;
a loose cut semiconductor device; or
an on package semiconductor device.

20. The computer-implemented method of claim 15, further comprising:
employing a result of the comparison to at least one of:
validate that no malicious circuitry has been injected in the sample;
detect evidence of infringement, by the sample, of intellectual property;
detect a defect in the sample; or
perform silicon validation of the sample.
